(19) United States
(12) Patent Application Publication
(10) Pub. No.: US 2010/0318400 A1
(43) Pub. Date: Dec. 16, 2010

(54) METHOD AND SYSTEM FOR LINKING INTERACTIONS

(76) Inventors: David GEFFEN, Givat Shmuel (IL); Offer HASSIDI, Kiriat Ono (IL); Yoav FREIBERGER, Tel Aviv (IL)

Correspondence Address: Pearl Cohen Zedek Latzer, LLP, 1500 Broadway, 12th Floor, New York, NY, 10036, US

(21) Appl. No.: 12/485,180

(22) Filed: Jun. 16, 2009

(51) Int. Cl. G06Q 10/00; G06Q 50/00; H04M 3/00

(52) U.S. Cl. 705/9; 705/11; 379/265.06

(57) ABSTRACT

Embodiments of the invention are directed to a system and method for linking interactions. The method includes grouping a plurality of customer-agent interactions into a category upon identifying one or more predetermined common characteristics in the customer-agent interactions and linking at least two of said customer-agent interactions to form a chain of interactions upon identifying a condition that matches a predetermined rule defining the chain.

### BACKGROUND

Many companies and businesses operate a centralized communication center, such as a call center or a contact center to handle incoming and outgoing interactions with clients and customers. For example, companies and businesses which include telemarketing methods, product services, debt collection and customer support.

Although interactions with clients have typically two parties, the agent and the client, the focus of quality management and recording solutions is mainly targeted at the agent side, primarily aiming to improve the agent's performance and maximize operational efficiency.

Customer relationship management (CRM) applications are targeted to increase customer satisfaction and deal with issues such as customer experience, customer relationship and process improvements and operational efficiency at contact centers CRM applications, however do not have control over the interactions themselves. Therefore, there are no management solutions that use the content of interactions and information extracted from interactions to improve customer experience and customer relationship.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an exemplary block diagram of a communication and interaction capturing system according to embodiments of the present invention;

FIG. 2 is a flowchart of a method for linking interactions according to embodiments of the present invention; and

FIGS. 3A-3F are exemplary depictions of portions of a computer screen showing an exemplary graphical user interface helpful in performing embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF DEMONSTRATIVE EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of devices” may include two or more devices.

Although embodiments of the invention are not limited in this regard, the term “contact center” as used herein may be used throughout the specification and claims to describe any centralized or distributed locations used for collective handling of multi-media information, for example, telephone calls, faxes, e-mails and the like, or any other centralized or distributed locations used for the purpose of receiving, transmitting and controlling a large volume of information.

Although embodiments of the invention are not limited in this regard, the terms “call” or “interaction” as used herein may be used throughout the specification and claims to describe a communication session between two or more parties and may include, for example, a telephone call, a VoIP telephone call, an instant messaging session, an electronic mail (e-mail), web collaboration, chat, video conference session or any other multi-media session or interaction.

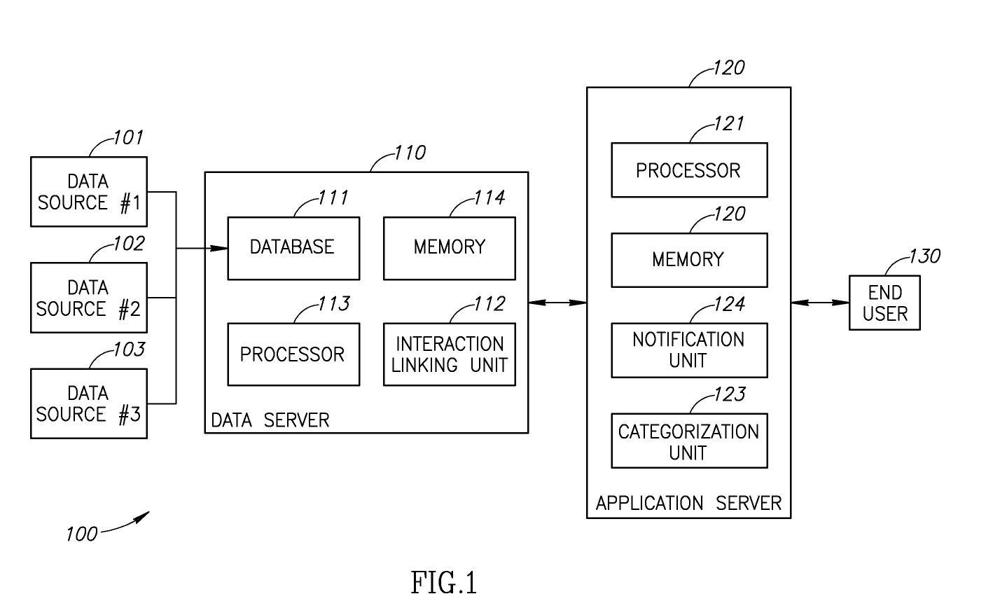

Reference is now made to FIG. 1, which is a block diagram of an exemplary communication and interaction capturing system according to embodiments of the present invention. For example, the communication system may be a contact center, a call center or any other communication system that handles multiple interactions. It should be understood to a person skilled in the art that the architecture of the exemplary communication system described below does not limit the scope of the invention and embodiments of the invention may be implemented in other systems.

According to embodiments of the invention, an exemplary system 100 may provide the infrastructure for automatic analysis and creation of links between different customer-agent interactions to enable delivery of automatic alerts (notifications) upon occurrence of triggering events related to the linked customer interactions. Embodiments of the invention may include receiving interactions and data related to the received interactions, collecting and/or extracting information from the interactions and from the data related to the received interactions, grouping interactions into a category based on one or more predetermined characteristics in the interactions and automatically linking at least two of the interactions to form a chain based on predetermined rules.

Embodiments of the invention may further provide an automatic analysis of customer-agent interactions. The analysis may be used to improve the performance of an individual agent and/or groups of agents, to detect and manage potentially unsatisfied customers and to improve the efficiency of processes in contact centers. For example, system 100 may automatically identify customers calling multiple times in a short period of time and may differentiate between a first case where all the multiple interactions of a costumer are related to the same issue and a second case where the multiple interactions of the customer are not related to the same issue. According to embodiments of the invention, the interactions may be categorized using various predetermined definitions. The categorization of the interaction may be used to determine whether a new interaction should be linked to a stored interaction or a stored chain of two or more interactions.

Communication system 100 may include a plurality of data sources, for example data sources, 101, 102 and 103, all coupled to a central data server 110. Central data server 110 may be coupled to an application server 120, which may be connected to one or more end-user devices 130. End-user device 130 may be handled by system administrators, contact center agents, managers and the like. End-user device 130 may access application server 120 via another application, such as web browser.

Each data source 101-103 may store recorded interactions, such as client-agent interactions and then provide the recorded interactions to data server 110. The term recorded interaction may include both the content of the interaction and additional data related to interactions, such as, for example, screen data and record details of the interactions. Data source 101 may be, for example, a voice interaction repository that may include for example, stored interactions, recordings of interactions and results of content analytics of the interactions. The content analysis may include using applications such as speech-to-text, word spotting and emotion detection. Data source 101 may further provide call flow information including, for example, ring-time, hold-time, hang-up side and/or any other information derived from or related to the interaction or its content.

Data source 102 may include for example, data related to the agents handling the customer-agent interactions including, for example, screen content and analytics of screen content. Further, data source 102 may include screen events and business data originating from the agents' computer screens.

Data source 103 may include, for example, a management application, such as a CRM system that may provide data related to the recorded interactions, for example, customer data, transaction history, customer preferences and restrictions. Data source 103 may further provide customer feedback information, such as, quality of service and the like. It should be understood to a person skilled in the art that any other data source that provides interaction-related data may used.

Central data server 110 may include a database 111, a memory 114, a processor 113 and an interaction linking unit 112. Database 111 may store data received from data sources 101-103 including, for example, audio recordings of interactions, electronic-mails, content and analytics of agent's screen activity and data from a third party such as CRM systems. Database 111 may be any suitable memory unit or storage medium. In some embodiments of the present invention, database 111 may be located inside central data server 110 while in other embodiments, database 111 may be external to data server 110.

Interaction linking unit 112 may use data stored in database 111 to extract information and/or to collect information from the stored data and to automatically link between two or more interactions according to predetermined characteristics and rules as described with reference to embodiments of the invention. Embodiments of the invention may be implemented in software and may include instructions or software code which may be stored in memory 14 and may be executed by processor 113.

Application server 120 may host an application programming interface (API) and may include a set of routines, data structures, object classes and/or protocols provided by libraries and/or operating system services in order to support the interaction linking process of interaction linking unit 112. Application server 120 may include a categorization unit 123 to receive information such as parameters, linking characteristics and other control information from user device 130 and a notification unit 124 to provide user device 130 with information, such as notification and alerts regarding interactions. Application server 120 may further include a memory 122 to store instructions or software code, e.g., of the API, and a processor 121 to execute the instructions stored in memory 122.

Central data server 110 and application server 120 may further include any other component, element or device of a computing device such as, a controller, a monitor or display, an operating system, input device(s) and output device(s).

According to embodiments of the invention, memory elements such as database 111, memory 122 and memory 114 may include any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, various types of Digital Video Disks (DVDs), a tape, a cassette, or the like.

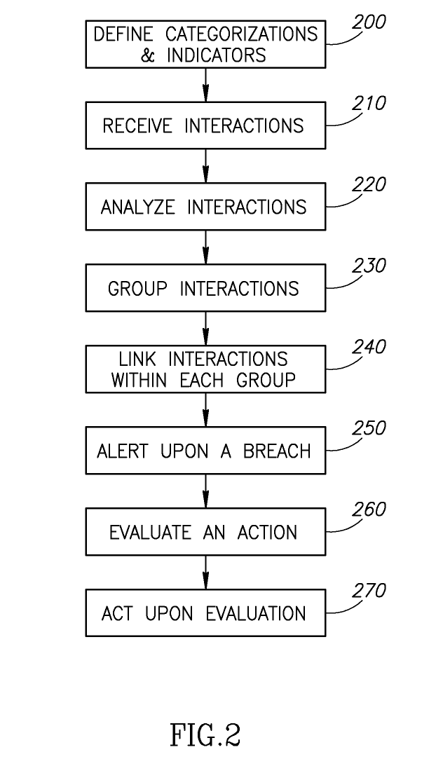

Reference is now made to FIG. 2, which is a flowchart of a method for linking interactions according to embodiments of the present invention. Operations of the method may be implemented by, for example, data server 110 and application server 120 of FIG. 1, and/or by other suitable units, devices, and/or systems.

Embodiments of the invention may include a computer-implemented method for handling customer-agent interactions, the method may include grouping a plurality of customer-agent interactions into a category upon identifying one or more predetermined common characteristics in the customer-agent interactions and linking at least two of said customer-agent interactions to form a chain of interactions upon identifying a condition that matches a predetermined rule defining the chain. The method may further include determining one or more key performance indicators (KPI's) for the chain, identifying a breach of one of the KPI's and issuing an alert upon identifying the breach.

As indicated at box 200, the method may include a preliminary definition stage for defining and setting parameters, such as, categories and indicators for linking interactions, defining rules for creating chains of linked interactions and further defining alert rules based on triggering events. The definition stage may be an initialization stage or an update stage during real-time operation of the system. For example, categories, indicators, triggering events and rules may be changed, modified or adapted during operation. A user may define and set parameters for grouping and linking interactions by, for example, providing data using an input device (not shown) to application server 120.

According to embodiments of the invention, the categorization may include defining types or categories of interactions where each interaction may be categorized in one or more categories. Two or more interactions having the same category may be grouped into a single chain. Grouping a plurality of customer-agent interactions into a category may be performed upon identifying one or more predetermined common characteristics or parameters in the customer-agent interactions. The parameters may be derived from one or more data sources, e.g., data sources 101-103 and may be stored in a dedicate data base, such as database 111 of data server 110. The one or more predetermined common characteristics may be based on, for example, an Interactive Voice Response (IVR) application, content analysis application, CRM application or any other data which may include, for example, CTI data, business data and any other data of interactions or interaction-related data from which parameters may be extracted. For example, CTI data may provide parameters such as length of a call, origin of a call and identity of the agent handling the interaction. The business data may provide parameters such as, the nature of the call, e.g., sale calls or service calls, customer type and the like. An example of a category for client-agent interactions may include a categorization according to the identity of the agent handling the call, namely, all interactions handled by a particular agent may be grouped in a category. Another example may include grouping sales-related interactions in one category and service-related interactions in another category or grouping interactions based on the identity of the client.

One or more chains of interactions may be defined within each category. A definition may include criteria for linking interactions within the same category. Linking interactions may include identifying a condition that matches a predetermined rule defining the chain. The definition of a predetermined rule defining a chain within a category of interactions may include defining a rule based on time span, for example, defining a period of time between interactions. Each category of interactions may have different chain definitions, e.g., the definition of a chain within the sales-calls category may be different from the definition of a chain within the service-calls category. For example, a first chain may be defined within the service-calls category for two calls having a time span of 5 days and directing to a common subject and client and a second chain may be defined within the sales-calls category enabling a time span e.g., 10-15 days between two calls.

Further, according to embodiments of the invention, key performance indicators (KPI's) for the chains may be defined and pre-determined. The Key performance indecators are also referred to herein as “indicators” or “indications” for each chain. The KPI's may be set and defined by an end user in order to provide chain measurement or evaluation. Each KPI may include one or more rules which a chain of interactions should comply with. If a chain of interaction violates the KPI an alert or a notification may be provided to a user upon breach of one or more of the indicators as further describe at box 250.

The KPI's may be defined, for example, based on customer data such as customer status, e.g., gold customer, silver customer etc. or based on the location of customer, e.g., grouping customer based on various regions. The key performance indicators are chain-oriented and customer-parameters-oriented, for example, in sale interactions a chain length threshold for silver customers may not be the same as a chain length threshold for platinum customers.

Examples of KPI's may further include a desired maximum number of interactions within a chain, namely chains that contain more than a predetermined number of calls may violate the KPI, maximum chain duration over a predetermined period of time, maximum total interactions duration over a predetermined period of time, a certain level of first contact resolved (FCR), which mat be defined as the total number of calls resolved during a first contact divided by total number of first calls, a certain level of call resolution rate (CRR) of an agent, which may be defined by the total number of calls resolved divided by the total number of calls. Other examples of key performance indicators may be used.

As indicated at box 210, the method may include receiving an interaction and/or data related to an interaction, for example, receiving an interaction or a call from a customer by an agent in a call center. The method may further include analyzing of the received call and extracting useful information and data from the received call as indicated at box 220. The interactions may be received from one or more data sources, for example, data sources 101-103 of FIG. 1 and may include the content of interactions, recordings of interactions, screen content and the like.

Analysis of the interaction may provide data related to the interactions, for example, content analytics, such as speech-to-text, word spotting and emotion detection, call flow information such as ring time, hold time, hang-up side and analytics of screen content, for example, screen events and business data from the computer screens of the agents. An interaction may further include other types of communication sessions such as, faxes, e-mails, video recordings or any other type of interaction. The analysis of the received interactions may further provide data related to interactions derived by a management application or system, such as a CRM system and may include, for example, customer data, transaction history, customer preferences and restrictions and the like.

As indicated at box 230, the method may include grouping a plurality of customer-agent interactions into categories or types upon identifying or according to one or more predetermined common characteristics or other predefined criteria. Examples of categories of interactions may include, calls answered by the same agent, calls having the same subject, calls from the same client and the like.

As indicated at box 240, the method may include automatically linking at least two of the customer-agent interactions within each of the plurality of groups or categories to form a chain of interactions upon identifying a condition that matches a predetermined rule defining a chain (defined at box 200).

In the exemplary communication system of FIG. 1, grouping and linking of interactions may be performed by interaction linking unit 112 based on definitions and settings provided by end user 130 to categorization unit 123 of application server 120. Interaction linking unit 112 may use data stored in database 111, such as CTI data and business data received from one or more of data sources 101-103.

Linking of interactions may be performed based on data extracted from interactions or data related to interaction such as, for example, time span permitted between two interactions, identical screen captured fields or events in two or more interactions, common phrases within two or more interactions and/or common business data fields related to two or more interactions.

As indicated at boxes 250, the method may include alerting or notifying a user upon breach of one or more indicators or KPI's. The method may include identifying a breach of one of the KPI's and issuing an alert upon identifying the breach. The KPI's may be provided, for example to notification unit 124. The indicators may include one or more rules being analyzed in view of one or more factors such as, call type, customer type, agent, customer satisfaction of resolved interaction and customer attributes such as age, location, gender.

For example, a KPI of a predetermined number of interactions per chain may be analyzed by counting the interactions in the chains (number of chains with X or Y interactions), chain size by line of business (sale category may include X chains while service category may include Y chains), chain size by customer type (gold customers may have X chains with more than Z interactions while silver customers may have Y chains with more than Z interactions) and\or chain size by customer satisfaction of resolved interaction.

Another example, a KPI of a predetermined period of a chain, namely, from the start time of the first interaction until the end time of the last interaction in the chain may be analyzed according to chain period by line of business, chain period by customer type, chain period by customer attributes and\or chain size by customer satisfaction of resolved interaction. A KPI of a predetermined chain handle time, namely, an accumulation of handling time of all the interaction of a chain may be analyzed according to chain handle time by line of business, a chain handle time by customer type, a chain handle time by customer attributes and\or chain handle time by customer satisfaction of resolved interaction.

Other examples may include a key performance indicator based on first contact resolved (FCR) level, namely, an issue resolved on a first interaction may be analyzed according to a desired FCR level per department, group, team and agent, FCR by handle time, FCR by hour of the day, FCR by quality. A key performance indicator based on call resolution rate (CRR) level and may be analyzed according to CRR per department, group, team and agent, CRR by handle time, CRR by hour of the day or CRR by quality. It should be understood to a person skilled in the art that any other indicators or KPI's may be analyzed according to any other parameter or combination of parameters.

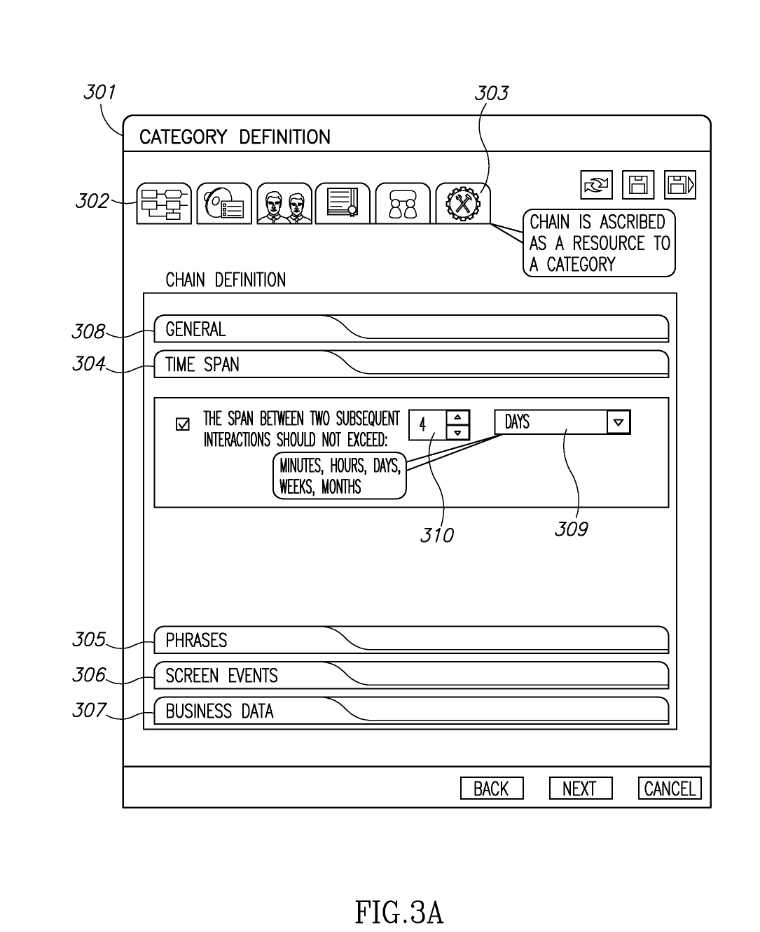

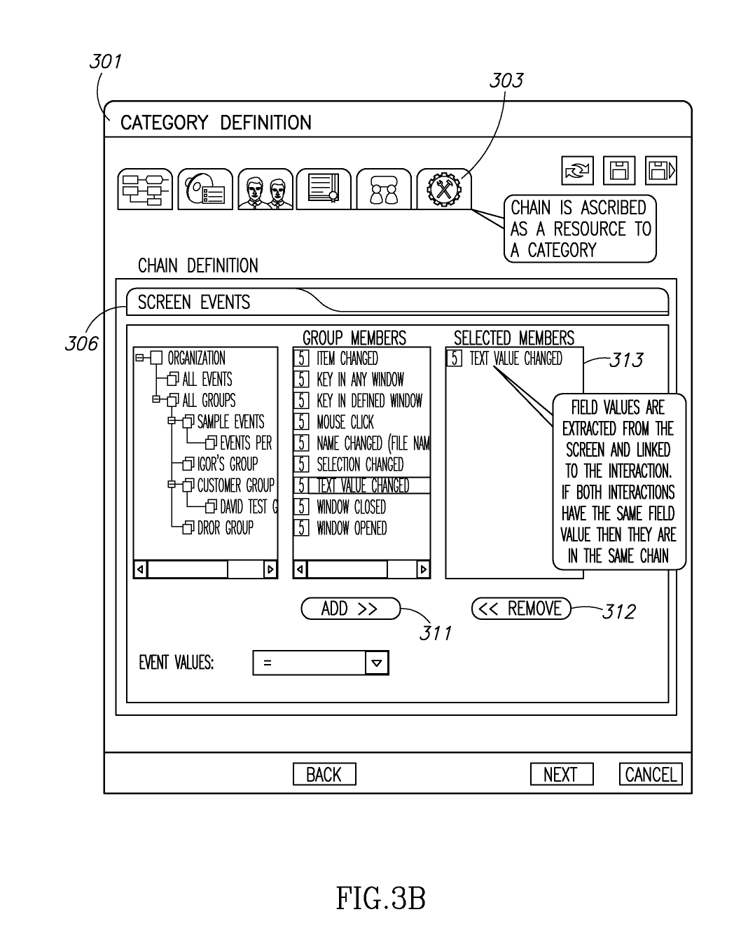

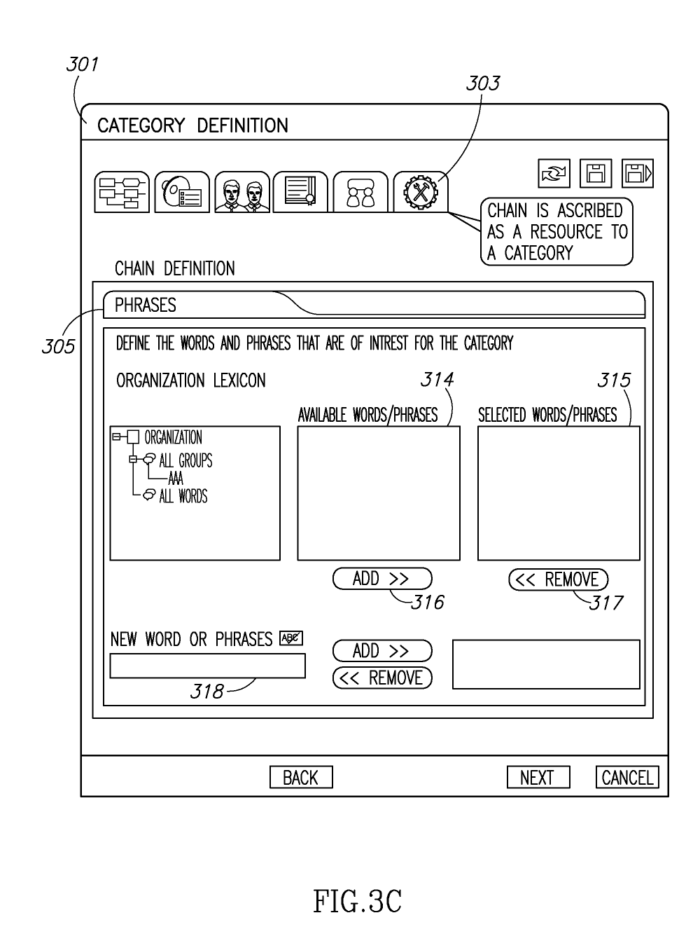

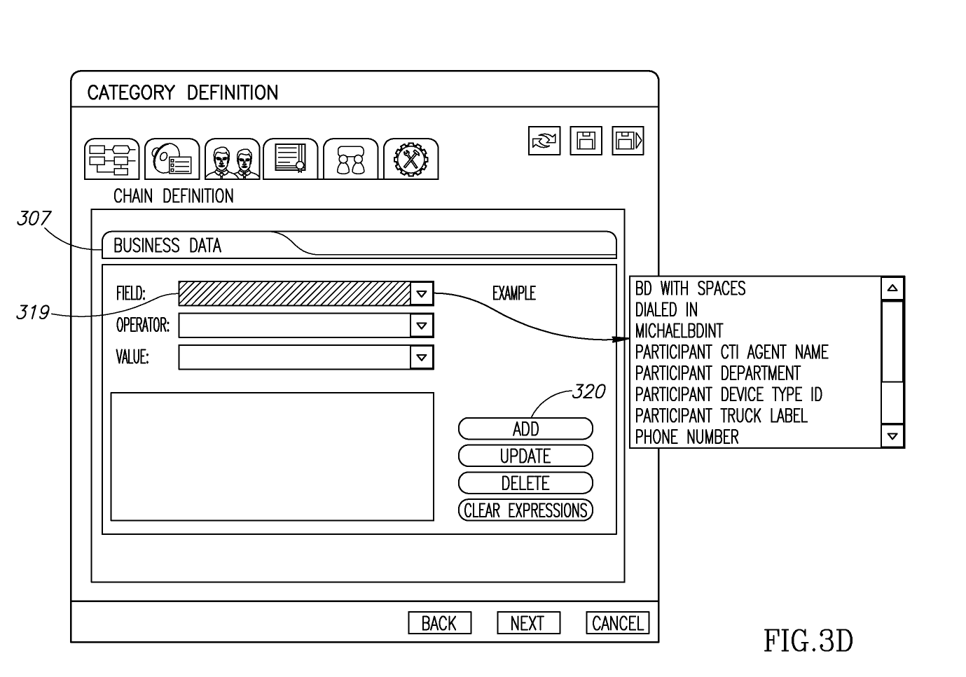

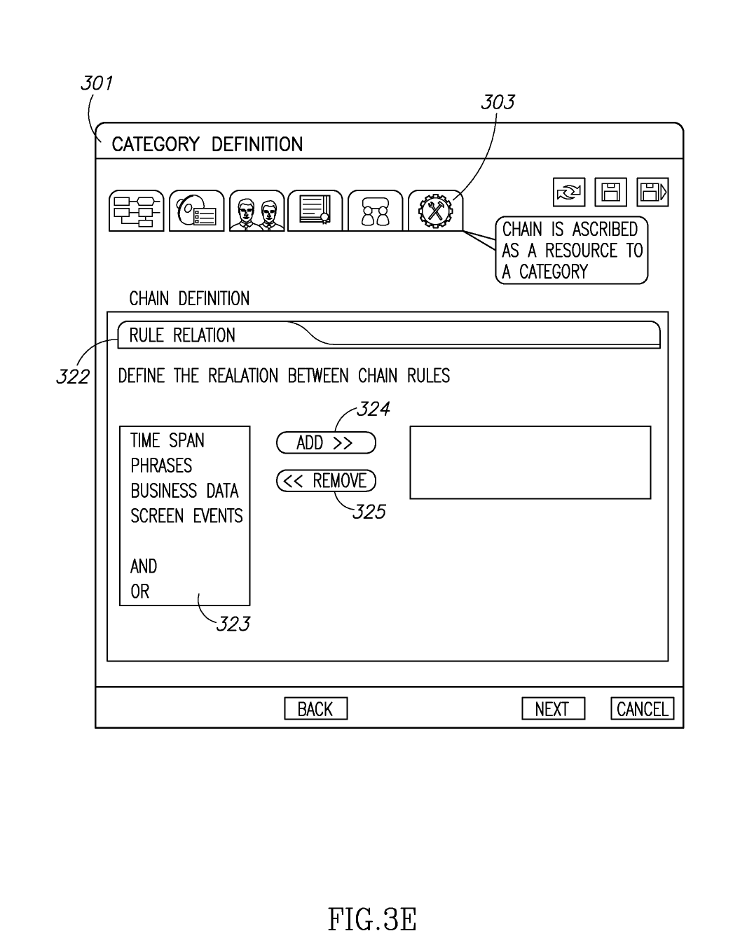

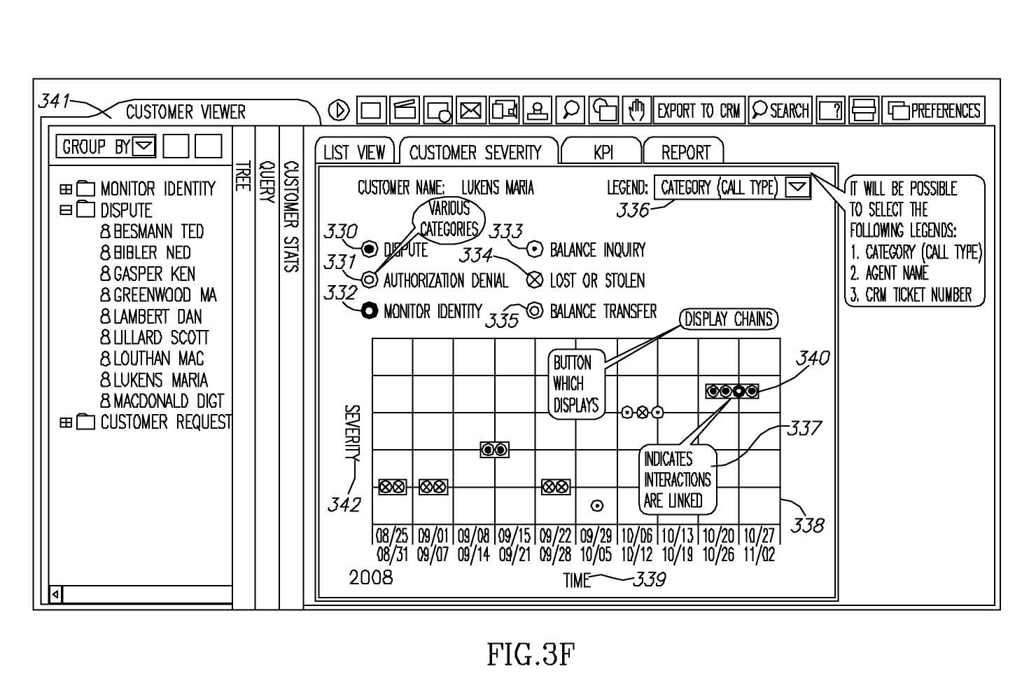

As indicated at box 260, the method may include evaluating an action based on breach of one of the KPI's and acting upon the action evaluated as indicated at box 270. Embodiments of the invention may include evaluation of an action by analysis and investigation of interaction chains and breached indication automatically or by a user or a system administrator. For example, evaluating of an action may include defining a coaching plan for agents to improve client-agent interactions or modifying processes of a contact center for dealing with specific customer issues. Analysis and investigation of interaction chains and breached indications may be performed by using a graphical user interface, for example, as described with reference to FIG. 3F.

Exemplary issues which may be considered, evaluated and acted upon may include customer behavior, agent's performance and multiple internal processes of the contact center. Customer related actions for improving customer satisfaction and customer experience may include, for example, updating information received from a CRM system with relevant data based on the interactions, linking various CRM applications to directly access an interaction when required, notifying to relevant functions in the contact center to take corrective measures, e.g. change marketing campaign, competition analysis, customer call back and the like. In addition Overall customer behavior may be analyzed and reported upon in an aggregate level, providing business insight on the way different types of customers interact with the contact center, behavior patterns and experience level.

Agent performance related actions for improving agent behavior or agent knowledge may include, for example, defining a coaching plan for relevant agents regarding customer related issues according to the investigation of interaction chains and notifying agent to relevant functions in the contact center per analysis of his performance, e.g., updating agent development plan, knowledge gaps, evaluation plans and the like. Modification of processes of the contact center may include, for example, modifying processes for dealing with specific customers or specific customer issues, e.g., special policy for dealing with gold customers and improving processes where a flow of agent's activity is malfunctioning.

Other operations or sets of operations may be used in accordance with embodiments of the invention.

Reference is now made to FIGS. 3A-3F, which are exemplary depictions of portions of a computer screen showing an exemplary graphical user interface helpful in performing embodiments of the present invention. Although embodiments of the invention are not limited in this regard, a processor, for example, processor 121 of application server 120 of FIG. 1, may be programmed so as to provide a variety of pre-determined menu choices of an graphical user interface which may be selected by a user operating the processor via an input device, for example, by end user 130 of FIG. 1.

FIGS. 3A-3E presents a plurality of graphical views of a computer screen which may be used to define chains of interactions during defining stage presented at box 200 of FIG. 2. As presented in FIG. 3A, each category definition, shown in a title box 301, may include toolbar 302 which may include a plurality of convenience tools. Convenience tool 303 may allow defining a chain by a plurality of screens 304-308, each screen may allow to define a rule regarding linking interactions.

Screen 304 may allow a time span definition by which a user may define the required time span between two subsequent interactions with resolution of months, weeks, days and hours as shown in boxes 309 and 310. Chain definition may further include defining screen events as shown in FIG. 3B.

As shown in FIG. 3B, screen 306 may allow adding and removing events or screen captured fields by buttons 311 and 312 to the selected events column 313. The selected field values may be extracted from the screen and linked to an interaction. If two or more interactions from the same category have the same field value they may be linked and considered as part of the same chain. Chain definition may further include defining of common phrases detected, for example, by audio analysis capabilities as shown in FIG. 3C.

As shown in FIG. 3C, screen 305 may allow defining words or phrases that are interest for the category and may link interactions which such words or phrases are being used in them by adding and removing words or phrases from available words or phrases column 314 to column 315 by buttons 316 and 317 or by defining a new word or phrase in box 318. Chain definition may further include defining of business data fields as shown in FIG. 3D.

As shown in FIG. 3D, screen 307 may allow defining business data fields in box 319, which may be attached to interactions, selected by add button 320 and link interactions if such fields exist in two or more interactions. Chain definition may further include defining of rule relation as shown in screen 322 of FIG. 3E.

As shown in FIG. 3E, column 323 may include the rules defined by screens 304-308 of FIGS. 3A-3D and may allow adding and removing of rules and the relation between them by buttons 324 and 325. For example, a user may select to combine rules and create a rule that only a match of “time span” and “common phrases” may be sufficient to link two or more interactions.

Once a chain is defined as part of a category as presented in FIGS. 3A-3E, interactions may be linked and a privileged user may be notified regarding breach of pre-determined KPIs. A user may investigate the interaction chains by a dedicated graphical screen, for example, as presented in FIG. 3F.

As shown in FIG. 3F, each interaction may be displayed with a different mark or color 330-335 to reflect its relevant group defined in box 336, for example, category, agent name, or CRM ticket number. In addition the user may define a selected customer in customer viewer 341. The interaction chains are marked, as presented by balloon 337 and are placed in a customer/severity/time screen 338 along a time line 339. The linked interaction may be placed vertically based on their severity score as determined by the KPI's. For example, interactions chain 340 includes four interactions from the same customer, all interactions performed within seven days while three of them included dispute and therefore are placed high in the severity axis 342.

Following the analysis of FIG. 3F, various actions may be considered in order to address different situations. For example, action such as evaluation and coaching relevant agents who participated in the detected interaction chain. Rather than focusing on a single agent with single interactions, a new perspective and the focus may be given on the entire interaction chain and the performance of all agents who took part in a chain as a group. As of such group coaching and evaluation may be supported. In addition a relevant customer may be “marked” so that experienced agents may deal with specific “marked” customers or customer groups. Analysis such as presented in FIG. 3F, may provide business insight on malfunction processes and polices in the organization or in a contact center. For example, even when all agents are doing as required, due to poor business process structure the customer may experience a low level of satisfaction. A user may identify via customer analysis the key pain points and malfunctioning process and may take corrective actions.

The analysis may further provide reports regarding aggregate customer chain trends, cross correlations between chain parameter and other operational and customer satisfaction statistics. Examples of various supported reports may include customer group chain length, namely number of interactions, over time, broken down by call types, customer group chain duration, namely time span over time, agent or agent group FCR trend over time crossed with quality score, agent or agent group CRR trend over time crossed with quality score and histogram per customer groups chain length compared with customer satisfaction score.

Measuring and managing customer interactions based on interaction chains according to embodiments of the present invention may have several advantages, for example, customer experience level may be automatically measured and alerted upon based on the relevant call type and chain KPI, thus pushing rather than pulling customer issues to the end user. This may aid in addressing in a more proactive and efficient fashion customer satisfaction and experience related topics. In addition a snapshot of customer experience over time may be available in a graphic mode so that gaining understanding of the customer's level of satisfaction with the service he is being provided by the organization is straight forward and further it may be possible to identify via customer chain length process which are taking longer than others and correct them if necessary.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

Embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components. In some embodiments, such system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

Some embodiments may be provided in a computer program product that may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A computer-implemented method for handling customer-agent interactions, the method comprising:
grouping a plurality of customer-agent interactions into a category upon identifying one or more predetermined common characteristics associated with the customer-agent interactions;
linking at least two of said customer-agent interactions to form a chain of interactions upon identifying a condition that matches a predetermined rule defining the chain;
determining one or more key performance indicators (KPI's) for the chain;
identifying a breach of one of the key performance indicators; and
issuing an alert upon identifying the breach.

2. The method of claim 1, wherein identifying the one or more predetermined common characteristics is based on an Interactive Voice Response (IVR) application.

3. The method of claim 1, wherein identifying the one or more predetermined common characteristics is based on content analysis application.

4. The method of claim 1, wherein identifying the one or more predetermined common characteristics is based on a Customer relationship management (CRM) application.

5. The method of claim 1, wherein the rule defining the chain determines a desired time span for the customer-agent interactions in the chain.

6. The method of claim 1, wherein one of the key performance indicators determines a desired maximum number of interactions allowed within the chain.

7. The method of claim 1, wherein one of the key performance indicators determines a desired time span between a first and last interaction in the chain.

8. The method of claim 1, wherein one of the key performance indicators determines maximum total interactions duration over a predetermined period of time.

9. The method of claim 1, further comprising:
evaluating an action based on the alert upon identifying the breach of one of the key performance indicators; and
acting upon the action evaluated.

10. The method of claim 9, wherein evaluating comprises defining a coaching plan for agents.

11. The method of claim 9, wherein evaluating comprises modifying processes of a contact center.

12. A system for handling customer-agent interactions, the system comprising:
a plurality of data sources to provide the customer-agent interactions;
a data server to group a portion of the customer-agent interactions into a category upon identifying one or more predetermined common characteristics associated with the portion and to link at least two of the customer-agent interactions in the category to form a chain of interactions upon identifying a condition that matches a predetermined rule defining the chain; and
an application server to store definitions of one or more key performance indicators (KPI's) for the chain, to identify a breach of one of the key performance indicators and to issue an alert upon identifying the breach.

13. The system of claim 12, wherein the application server is further to store the predetermined common characteristics and predetermined rules defining chains.

14. The system of claim 12, wherein the data server receives information from an Interactive Voice Response (IVR) application.

15. The system of claim 12, wherein the data server receives information from an content analysis application.

16. The system of claim 12, wherein the data server receives information from a Customer relationship management (CRM) application.

17. An article comprising a computer-storage medium having stored thereon instructions that, when executed by a processing platform, result in:
grouping a plurality of customer-agent interactions into a category upon identifying one or more predetermined common characteristics associated with the customer-agent interactions;
linking at least two of said customer-agent interactions to form a chain of interactions upon identifying a condition that matches a predetermined rule defining the chain;
determining one or more key performance indicators (KPI's) for the chain;
identifying a breach of one of the key performance indicators; and
issuing an alert upon identifying the breach.
